(19) United States
(12) Patent Application Publication
(10) Pub. No.: US 2020/0388893 A1
(43) Pub. Date: Dec. 10, 2020

(54) BATTERY PACK ASSEMBLY

(71) Applicant: GM GLOBAL TECHNOLOGY OPERATIONS LLC, Detroit, MI (US)

(72) Inventors: Robert J. Schoenherr, Oxford, MI (US); Phillip D. Hamelin, Clarkston, MI (US); Alexander M. Bilinski, Avoca, MI (US)

(73) Assignee: GM GLOBAL TECHNOLOGY OPERATIONS LLC, Detroit, MI (US)

(21) Appl. No.: 16/431,194

(22) Filed: Jun. 4, 2019

(51) Int. Cl. H01M 10/6556; H01M 10/613; H01M 10/6568; H01M 10/625

(52) U.S. Cl. CPC H01M 10/6556; H01M 10/613; H01M 2220/20; H01M 10/625; H01M 10/6568

(57) ABSTRACT

A battery pack assembly includes a battery cell and a plurality of walls that surround the battery cell. The battery pack assembly also includes a heat exchanger coupled to the battery cell. The heat exchanger is configured to cool the battery cell. The heat exchanger includes a first frame and at least one channel supported via the first frame. The channel is configured to guide a liquid fluid through the channel to cool the battery cell. In certain configurations, the battery pack assembly includes a tray and a plurality of first battery cells electrically connected to each other to present a first cell stack. In certain configurations, the battery pack assembly includes a plurality of first walls that surround the first cell stack to define a first battery module coupled to the tray. The heat exchanger may be coupled to the tray and coupled to the first cell stack.

### INTRODUCTION

Electric vehicles and hybrid vehicles include a battery pack to supply power to drive one or more wheels of the vehicle during certain modes of operation. The battery pack may include a module that houses a battery formed of a plurality of cells. The battery pack may include a cooling plate that is configured to cool the cells of the battery pack. The cooling plate is formed of a solid material.

### SUMMARY

The present disclosure provides a battery pack assembly that includes a battery cell and a plurality of walls that surround the battery cell. The battery pack assembly also includes a heat exchanger coupled to the battery cell. The heat exchanger is configured to cool the battery cell. The heat exchanger includes a first frame and at least one channel supported via the first frame. The channel is configured to guide a liquid fluid through the channel to cool the battery cell.

The present disclosure also provides a battery pack assembly that includes a tray and a plurality of first battery cells electrically connected to each other to present a first cell stack. The battery pack assembly also includes a plurality of first walls that surround the first cell stack to define a first battery module. The first battery module is coupled to the tray. The battery pack assembly further includes a heat exchanger coupled to the tray and coupled to the first cell stack. Again, the heat exchanger is configured to cool the first cell stack. The heat exchanger includes a first frame and at least one channel supported via the first frame. The channel is configured to guide a liquid fluid through the channel to cool the first cell stack.

The detailed description and the drawings or FIGS. are supportive and descriptive of the disclosure, but the claim scope of the disclosure is defined solely by the claims. While some of the best modes and other embodiments for carrying out the claims have been described in detail, various alternative designs and embodiments exist for practicing the disclosure defined in the appended claims.

### BRIEF DESCRIPTION OF THE DRAWINGS

FIG. 1 is a schematic perspective view of a battery pack assembly, with a tray housing a plurality of battery modules, and a plurality of heat exchangers positioned relative to the respective battery modules.

FIG. 2 is a schematic perspective view of a battery module with a pair of heat exchangers incorporated into respective walls.

FIG. 3 is a schematic fragmentary cross-sectional view of one of the heat exchangers that may be incorporated into the wall of FIG. 2.

FIG. 4 is a schematic perspective view of one of the heat exchangers that may be incorporated into the wall of FIG. 2.

FIG. 5 is a schematic cross-sectional perspective view of the heat exchanger of FIG. 4.

FIG. 6 is a schematic perspective view of another battery module with a heat exchanger positioned between a pair of cell stacks.

FIG. 7 is a schematic perspective view of the heat exchanger that may be incorporated into the battery module of FIG. 6.

FIG. 8 is a schematic exploded perspective view of the heat exchanger of FIG. 7.

### DETAILED DESCRIPTION

Those having ordinary skill in the art will recognize that all directional references (e.g., above, below, upward, up, downward, down, top, bottom, left, right, vertical, horizontal, etc.) are used descriptively for the FIGS. to aid the reader's understanding, and do not represent limitations (for example, to the position, orientation, or use, etc.) on the scope of the disclosure, as defined by the appended claims.

Referring to the FIGS., wherein like numerals indicate like or corresponding parts throughout the several views, a battery pack assembly 10 is generally shown in FIG. 1.

The battery pack assembly 10 may be used in a vehicle, such as, but not limited to, an automobile, an off-road vehicle, a watercraft, an aircraft, or any other suitable movable platform. As non-limiting examples, the vehicle may be a hybrid vehicle or an electric vehicle. The hybrid vehicle may include an internal combustion engine and one or more electric motors to drive wheels of the vehicle. The electric vehicle may include one or more electric motors to drive the wheels of the vehicle.

The battery pack assembly 10 may store power and/or provide power to operate the electric motors that drive the wheels of the vehicle. As another example, the battery pack assembly 10 may store power and/or provide power to various auxiliary systems, such as a radio, one or more pumps, lights, etc. The battery pack assembly 10 may also be used in a non-vehicle system, such as, a power plant, etc.

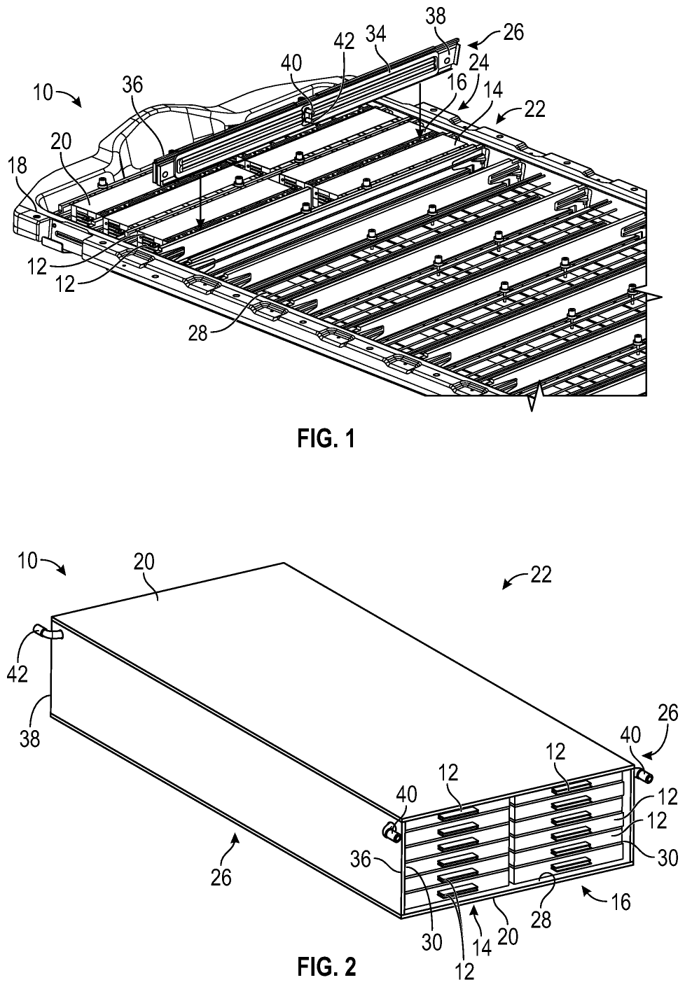

As best shown in FIGS. 1 and 2, the battery pack assembly 10 includes a battery cell 12. The battery cell 12 may be configured to store power and/or provide power to various components, some of which as discussed above. In certain configurations, more than one battery cell 12 may be used. Therefore, in certain configurations, the battery cell 12 is further defined as a plurality of battery cells 12 electrically connected to each other to present a cell stack 14, 16. The battery cells 12 may be any suitable configuration, and include any suitable material(s) to store power. The battery cells 12 may be stacked on top of each other as shown in FIGS. 1, 2, and 6.

In certain configurations, the battery cell 12 is further defined as a plurality of first battery cells 12 electrically connected to each other to present a first cell stack 14. Optionally, in various configurations, the battery pack assembly 10 may also include a plurality of second battery cells 12 electrically connected to each other to present a second cell stack 16. It is to be appreciated that any suitable number of cell stacks 14, 16 may be used.

Referring to FIG. 1, the battery pack assembly 10 may also include a tray 18. Generally, the tray 18 is disposed on a support or frame. The tray 18 may be secured to the support such that the tray 18 is stationary. The tray 18 may support any suitable number of battery cells 12, and hence, any suitable number of cell stacks 14, 16. The tray 18 may be any suitable configuration to support the battery cell(s) 12. Optionally, a cover may be coupled to the tray 18 to close the battery pack assembly 10.

Referring to FIGS. 1, 2, and 6, the battery pack assembly 10 includes a plurality of walls 20 that surround the battery cell 12. The walls 20 may partially or completely surround the battery cell(s) 12. Therefore, for example, no wall 20 may be disposed along one or more sides of the battery cell(s) 12.

In certain configurations, the walls 20 are further defined as a plurality of first walls 20, and optionally, the battery pack assembly 10 may include a plurality of second walls 20. As best shown in FIG. 1, the first walls 20 surround the first cell stack 14 to define a first battery module 22, and the first battery module 22 is coupled to the tray 18. Again, as best shown in FIG. 1, the second walls 20 surround the second cell stack 16 to define a second battery module 24, and the second battery module 24 is coupled to the tray 18. The tray 18 may support any suitable number of battery modules 22, 24. The first and second battery modules 22, 24 may be electrically connected together to provide the desired voltage to operate various components. Generally, any suitable number of battery modules 22, 24 may be used. It is to be appreciated that more than one cell stack 14, 16 may be surrounded via the walls 20, as best shown in FIGS. 2 and 6.

It is to be appreciated that any suitable number of walls 20 may be used to surround one or more battery cell(s) 12. Furthermore, the walls 20 may be any suitable configuration. For example, one or more of the walls 20 may be the same configurations, all of the walls 20 may be the same configurations, or all of the walls 20 may be different configurations. As another example, some of the walls 20 may be one configuration and some of the other walls 20 may another configuration, and so on depending on the number of walls 20. Furthermore, one or more ends or sides of the battery modules 22, 24 may be open. In other words, one or more ends or sides of the battery modules 22, 24 may not have a wall 20.

The battery pack assembly 10 also includes a heat exchanger 26 coupled to the battery cell 12 or the battery cells 12. The heat exchanger 26 may be directly or indirectly coupled to the battery cell(s) 12. The heat exchanger 26 is configured to cool the battery cell 12 or the battery cells 12. The heat exchanger 26 may use a liquid fluid, such as coolant, water, etc., to cool the battery cell(s) 12. When using one or more cell stacks 14, 16, the heat exchanger 26 is configured to cool the first cell stack 14 and/or the second cell stack 16, or any other number of cell stacks 14, 16 being used. In certain configurations, the heat exchanger 26 is coupled to the tray 18 (see FIG. 1). When using the cell stacks 14, 16, generally, the heat exchanger 26 is coupled to the first cell stack 14 and/or the second cell stack 16.

The location of the heat exchanger 26 relative to the battery cell(s) 12 may improve performance of the battery pack assembly 10 in a situation where an external force is applied to the vehicle, and may improve servicing of the battery pack assembly 10. Additionally, the location of the heat exchanger 26 relative to the battery cell(s) 12 may efficiently cool the battery cell(s) 12 while maintaining the liquid fluid at a desired distance away from the battery cell(s) 12. Furthermore, the location of the heat exchanger 26 minimizes thermal contact with the environment outside of the tray 18. So for example, as shown in FIGS. 1, 2, and 6, the heat exchanger 26 may be positioned generally vertical relative to a bottom 28 of the tray 18 or a bottom 28 of the battery module to maximize thermal transfer of the battery cell(s) 12 while minimizing thermal contact with the environment outside of the tray 18.

Depending on how many battery cells 12 are being used, more than one heat exchanger 26 may be used. For example, as shown in FIG. 1, a plurality of heat exchangers 26 may be used. The heat exchangers 26 may be attached to the tray 18 by fasteners, clips, snap fit, grooves in the tray 18, or any other suitable method to position the heat exchangers 26 in the tray 18. One suitable way to assemble the battery pack assembly 10 is to attach the heat exchangers 26 to the tray 18 and then insert the battery modules 22, 24 into the tray 18 between the respective heat exchangers 26. Alternatively, when the heat exchangers 26 are incorporated into one or more of the walls 20, the battery modules 22, 24 are inserted into the tray 18 and there is not a separate operation for the heat exchangers 26 and the battery modules 22, 24 as discussed for the other way to assemble the battery pack assembly 10 immediately above. The heat exchangers 26 also provide structural support to the tray 18 and the battery modules 22, 24, which are discussed further below with the structure of the heat exchangers 26.

One or more heat exchangers 26 may be disposed along one or more sides of the battery cell(s) 12. Generally, the heat exchanger 26 is disposed along the cell stack 14, 16. For example, one or more of the heat exchangers 26 may be disposed relative to one battery module 22, 24, such as shown in FIGS. 1 and 2. The heat exchanger(s) 26 may be disposed along the cell stack 14, 16 in different configurations. In certain configurations, one of the walls 20 is defined as the heat exchanger 26 as shown in FIG. 2. In the configuration where one of the walls 20 is defined as the heat exchanger 26, the heat exchanger 26 is disposed along an outside 30 of the cell stack 14, 16 or the first battery module 22. More specifically, in certain configurations, the heat exchanger 26 is disposed along the outside 30 of the cell stacks 14, 16.

In other configurations, the cell stack 14, 16 is further defined as a plurality of cell stacks 14, 16, and the heat exchanger 26 is disposed between the cell stacks 14, 16 as shown in FIG. 6. More specifically, the heat exchanger 26 may be disposed between the first and second cell stacks 14, 16. Therefore, in the configuration of FIG. 6, the heat exchanger 26 is also surrounded via the walls 20. For the configurations discussed herein, respective heat exchangers 26 may be disposed between a pair of the battery modules 22, 24 or the cell stacks 14, 16.

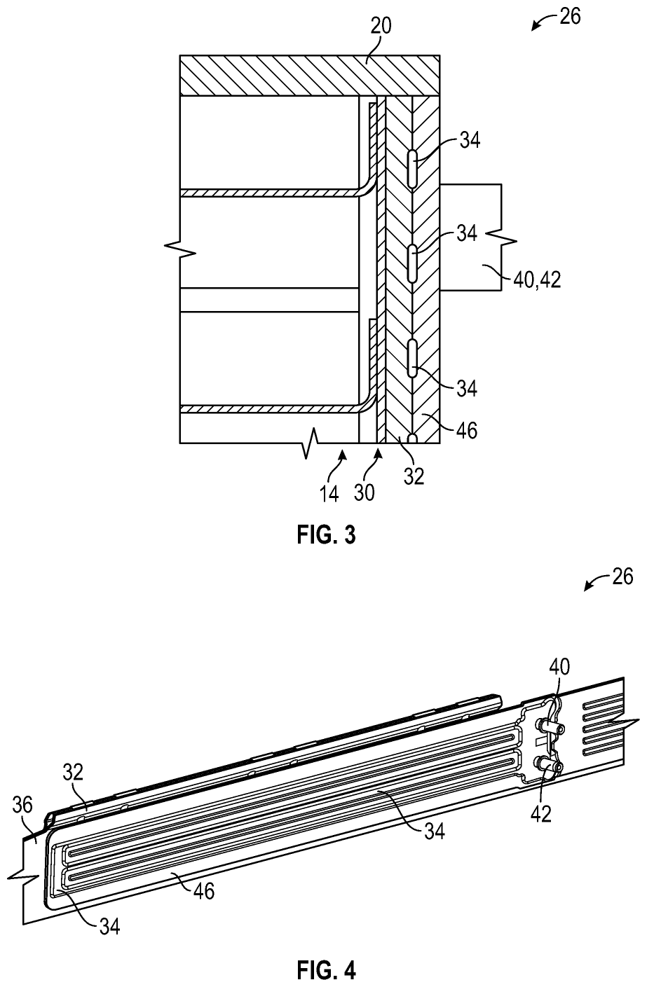

As best shown in FIGS. 3-5, and 7-8, the heat exchanger 26 includes a first frame 32 and at least one channel 34 supported via the first frame 32. The first frame 32 provides structural support for the battery cells 12 and/or the battery modules 22, 24. The channel 34 is configured to guide the liquid fluid through the channel 34 to cool the battery cell 12. In other words, the channel 34 circulates the liquid fluid relative to the battery cell(s) 12 to transfer heat away from the battery cell(s) 12 and cool the battery cell(s) 12. When using the cell stacks 14, 16, the channel 34 is configured to guide the liquid fluid through the channel 34 to cool the first cell stack 14 and/or the second cell stack 16. Therefore, as the liquid fluid travels through the channel 34, the liquid fluid increases in temperature due to the heat transfer via the battery cell(s) 12.

Generally, the first frame 32 may support the battery cell(s) 12. The first frame 32 may be coupled to the tray 18 to support the battery cell(s) 12, and more specifically, support the battery module(s) 22, 24. The first frame 32 may include a first end 36 and a second end 38 spaced apart from each other. The channel 34 extends across the first frame 32 between the first and second ends 36, 38. In certain configurations, the at least one channel 34 is further defined as a plurality of channels 34 that extend across the first frame 32 between the first and second ends 36, 38. Optionally, the channels 34 may be connected to each other. The battery cell(s) 12 may be stack relative to the heat exchanger 26 such that one of the sides of each of the cell(s) 12 are disposed adjacent to the heat exchanger 26 which allows each of the cell(s) 12 to be cooled.

Referring to FIGS. 2, 4, 6, and 7, the heat exchanger 26 may include an inlet 40 and an outlet 42 each in fluid communication with the channel 34. The inlet 40 and the outlet 42 are each exposed outside 30 of the walls 20 (see FIGS. 2 and 6). The inlet 40 guides the liquid fluid into the heat exchanger 26 and the outlet 42 guides the liquid fluid out of the heat exchanger 26. Therefore, once the liquid fluid exits the heat exchanger 26 via the outlet 42, the liquid fluid is cooled down and recirculated to the heat exchanger 26 via the inlet 40. If separate channels 34 are used, more than one inlet 40 and more than one outlet 42 may be used. Therefore, each of the separate channels 34 will have a respective inlet 40 and a respective outlet 42 in fluid communication therewith to guide the liquid fluid into and out of the heat exchanger 26.

The channel(s) 34 may be formed via various structures. As best shown in FIG. 3, the first frame 32 may form part of the channels 34. As best shown in FIG. 8, the heat exchanger 26 may include a tube 44 coupled to the first frame 32 such that the first frame 32 supports the tube 44. Each of these configurations are discussed further below.

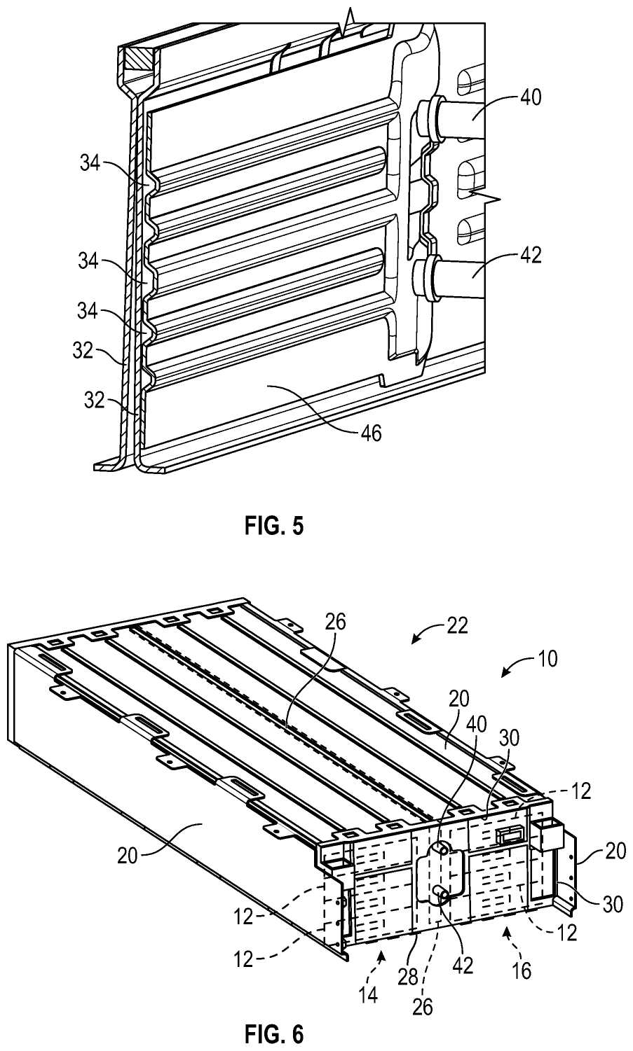

Turning back to FIG. 5, the heat exchanger 26 may include a second frame 46. The first and second frames 32, 46 cooperate to support the channel(s) 34. The first and second frames 32, 46 cooperate to provide structural support for the battery cells 12 and/or the battery modules 22, 24. The second frame 46 may also include a first end 36 and a second end 38 spaced from each other. The first end 36 of the first and second frames 32, 46 may be disposed adjacent to each other, and the second end 38 of the first and second frames 32, 46 may be disposed adjacent to each other.

Continuing with FIG. 5, in this configuration, the second frame 46 is attached to the first frame 32, and the channel 34 is defined between the first and second frames 32, 46. Generally, the channel 34 may be defined in the first frame 32 and/or the second frame 46. As such, in certain configurations, the first frame 32 or the second frame 46 may be flat to close one side of the channels 34 that are defined by the other one of the first frame 32 or the second frame 46. In other configurations, both of the first and second frames 32, 46 form part of the channels 34 (see FIG. 3). The first frame 32 and/or the second frame 46 are stamped to form the channel 34. For example, as best shown in FIG. 3, both of the first and second frames 32, 46 are stamped to form part of the channel 34. The first and second frames 32, 46 may be fixed to each other via any suitable methods, and non-limiting examples may include solder, adhesive, laser welding, bonding, etc.

As best shown in FIG. 4, the at least one channel 34 is further defined as the plurality of channels 34 that extend across the first frame 32 and/or the second frame 46. The first and second frames 32, 46 are secured to each other to form a unit. In this configuration, one of the walls 20 is defined as the unit, and the unit is disposed along an outside 30 of the battery cell(s) 12 (see FIG. 2). More specifically, the unit is disposed along the outside 30 of the cell stack(s) 14, 16 or the battery module(s) 22, 24. Therefore, the unit provides structural support to the battery module by acting as one of the walls 20, and the unit cooperates with the other walls 20 to surround the battery cells 12, which again provides structural support. It is to be appreciated that FIGS. 1 and 2 may also be illustrative of this of unit.

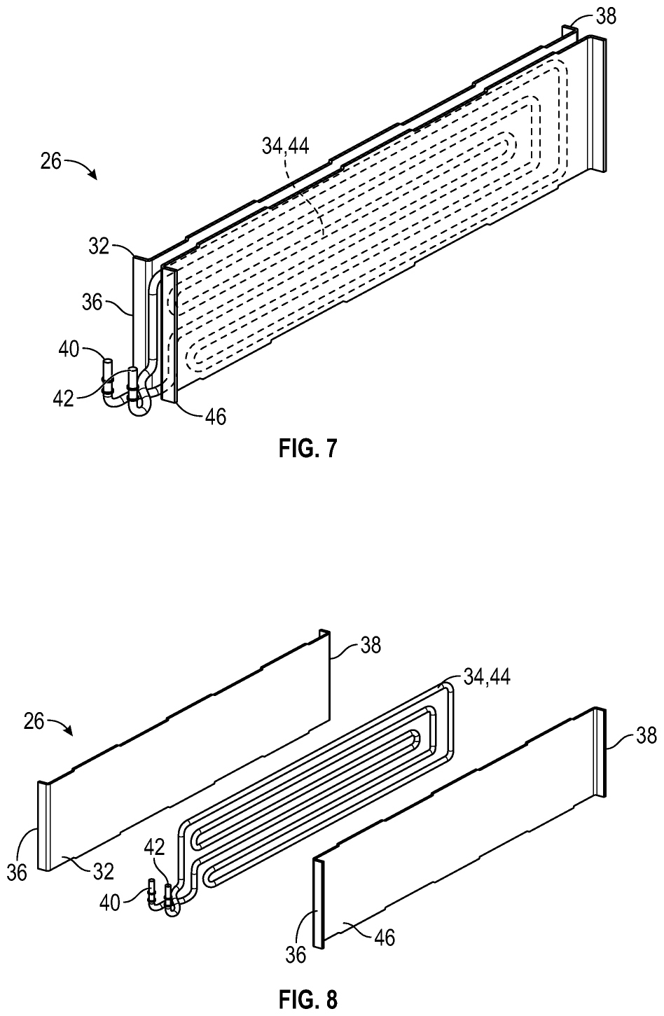

Referring to FIGS. 7 and 8, which illustrates the tube 44 configuration, the tube 44 may be one-elongated structure that defines the channel 34. In this configuration, the tube 44 may serpentine or wind back and forth. In other words, the tube 44 may be wrapped back and forth between the first and second ends 36, 38 of the first frame 32. Alternatively, the tube 44 may be formed of a plurality of pieces connected together.

Continuing with FIGS. 7 and 8, the heat exchanger 26 may include the second frame 46. The first and second frames 32, 46 cooperate to support the channel(s) 34. Therefore, the tube 44 may be wrapped back and forth between the first and second ends 36, 38 of the second frame 46. Again, the first and second frames 32, 46 cooperate to provide structural support for the battery cells 12 and/or the battery modules 22, 24.

Continuing with FIGS. 7 and 8, in this configuration, the tube 44 is disposed between the first and second frames 32, 46. The first and second frames 32, 46 and the tube 44 are secured to each other to form a unit. The first and second frames 32, 46 may be secured to each other via any suitable methods, and non-limiting examples may include brazing, etc. The first and second frames 32, 46 may be secured to each other via the tube 44. The unit is disposed between the first and second cell stacks 14, 16, and one example of this is shown in FIG. 6. In certain configurations, the heat exchanger 26, and more specifically, the unit is disposed between the first and second battery modules 22, 24. It is to be appreciated that FIGS. 1 and 6 may also be illustrative of this unit.

While the best modes and other embodiments for carrying out the disclosure have been described in detail, those familiar with the art to which this disclosure relates will recognize various alternative designs and embodiments for practicing the disclosure within the scope of the appended claims. Furthermore, the embodiments shown in the drawings or the characteristics of various embodiments mentioned in the present description are not necessarily to be understood as embodiments independent of each other. Rather, it is possible that each of the characteristics described in one of the examples of an embodiment can be combined with one or a plurality of other desired characteristics from other embodiments, resulting in other embodiments not described in words or by reference to the drawings. Accordingly, such other embodiments fall within the framework of the scope of the appended claims.

What is claimed is:

1. A battery pack assembly comprising:
a battery cell;
a plurality of walls that surround the battery cell;
a heat exchanger coupled to the battery cell, and the heat exchanger is configured to cool the battery cell; and
wherein the heat exchanger includes a first frame and at least one channel supported via the first frame, with the channel configured to guide a liquid fluid through the channel to cool the battery cell.

2. The assembly as set forth in claim 1 wherein the first frame includes a first end and a second end spaced apart from each other, and wherein the channel extends across the first frame between the first and second ends.

3. The assembly as set forth in claim 2 wherein the at least one channel is further defined as a plurality of channels that extend across the first frame between the first and second ends.

4. The assembly as set forth in claim 2 wherein the heat exchanger includes an inlet and an outlet each in fluid communication with the channel, and the inlet and the outlet are each exposed outside of the walls, and wherein the inlet guides the liquid fluid into the heat exchanger and the outlet guides the liquid fluid out of the heat exchanger.

5. The assembly as set forth in claim 1 wherein the heat exchanger includes a tube coupled to the first frame such that the first frame supports the tube, and the tube is one-elongated structure that defines the channel.

6. The assembly as set forth in claim 5 wherein the first frame includes a first end and a second end spaced apart from each other, and the tube is wrapped back and forth between the first and second ends of the first frame.

7. The assembly as set forth in claim 5 wherein the heat exchanger includes a second frame, and the tube is disposed between the first and second frames.

8. The assembly as set forth in claim 7 wherein the first and second frames and the tube are secured to each other to form a unit.

9. The assembly as set forth in claim 8:
wherein the battery cell is further defined as a plurality of first battery cells electrically connected to each other to present a first cell stack;
further including a plurality of second battery cells electrically connected to each other to present a second cell stack; and
wherein the unit is disposed between the first and second cell stacks.

10. The assembly as set forth in claim 1 wherein the heat exchanger includes a second frame attached to the first frame, and the channel is defined between the first and second frames.

11. The assembly as set forth in claim 10 wherein the channel is defined in the first frame and/or the second frame.

12. The assembly as set forth in claim 11 wherein the at least one channel is further defined as a plurality of channels that extend across the first frame and/or the second frame.

13. The assembly as set forth in claim 11 wherein the first and second frames are secured to each other to form a unit.

14. The assembly as set forth in claim 13 wherein one of the walls is defined as the unit, and the unit is disposed along an outside of the battery cell.

15. The assembly as set forth in claim 1 wherein:
the battery cell is further defined as a plurality of battery cells electrically connected to each other to present a cell stack; and
the heat exchanger is disposed along the cell stack.

16. The assembly as set forth in claim 15 wherein:
the cell stack is further defined as a plurality of cell stacks; and
the heat exchanger is disposed between the cell stacks.

17. The assembly as set forth in claim 15 wherein one of the walls is defined as the heat exchanger, and the heat exchanger is disposed along an outside of the cell stack.

18. A battery pack assembly comprising:
a tray;
a plurality of first battery cells electrically connected to each other to present a first cell stack;
a plurality of first walls that surround the first cell stack to define a first battery module, and the first battery module is coupled to the tray;
a heat exchanger coupled to the tray and coupled to the first cell stack, and the heat exchanger is configured to cool the first cell stack; and
wherein the heat exchanger including a first frame and at least one channel supported via the first frame, with the channel configured to guide a liquid fluid through the channel to cool the first cell stack.

19. The assembly as set forth in claim 18:
further including a plurality of second battery cells electrically connected to each other to present a second cell stack;
further including a plurality of second walls that surround the second cell stack to define a second battery module, and the second battery module is coupled to the tray; and
wherein the heat exchanger is disposed between the first and second battery modules.

20. The assembly as set forth in claim 18 wherein one of the walls is defined as the heat exchanger, and the heat exchanger is disposed along an outside of the first battery module.
